(19) United States
(12) Patent Application Publication
(10) Pub. No.: US 2016/0058130 A1
(43) Pub. Date: Mar. 3, 2016

(54) MULTI-PURPOSE CLOSURE SYSTEM

(71) Applicant: Boa Technology Inc., Denver, CO (US)

(72) Inventors: Grant Boney, Denver, CO (US); Sean Cavanagh, Golden, CO (US); Jesse Cotterman, Evergreen, CO (US); Ilya Minkin, Denver, CO (US); Michael Nickel, Golden, CO (US); Rebecca Peterson, Denver, CO (US); Mark Soderberg, Conifer, CO (US); Erik Swanson, Denver, CO (US); Aaron Venturini, Denver, CO (US); Tamara White, Denver, CO (US)

(21) Appl. No.: 14/839,537

(22) Filed: Aug. 28, 2015

Related U.S. Application Data
(60) Provisional application No. 62/043,296, filed on Aug. 28, 2014.

(51) Int. Cl. A43C 1/06; G01B 3/10; A43C 11/20; A43B 3/00; A61G 1/044

(52) U.S. Cl. CPC A43C 1/06; A43B 3/001; A61G 1/044; A43C 11/20; G01B 3/10

(57) ABSTRACT

A reel-based mechanism for tightening footwear includes a tension member and a plurality of guide members that are positioned about an opening of the footwear. The plurality of guide members guide or direct the tension member about a path along the footwear. The reel-based mechanism further includes a tightening mechanism that is operationally coupled with the tension member to effect tensioning of the tension member and tightening of the footwear upon operation of the tightening mechanism. The tightening mechanism performs one or more secondary functions that are not related to tightening of the footwear.

### CROSS-REFERENCE TO RELATED APPLICATIONS

The present application claims priority to U.S. Provisional Patent Application No. 62/043,296, filed on Aug. 28, 2014, the disclosure of which is hereby incorporated by reference in its entirety for all purposes.

### BACKGROUND OF THE INVENTION

Individuals may wish to pack lightly for trips and/or for day-to-day travel. For example, a hiker may bring a modest amount of outdoor gear for venturing into wilderness areas. However, such intentions may leave the individual in inconvenient situations where additional gear is desirable or critical for survival. For example, an individual in a remote location may need to summon emergency rescue and/or cure incurred ailments or injuries. In other examples, the individual may need to improvise on the spot to address emergency and/or any non-emergency situations with the limited gear. This application is intended to address these and other issues, and to provide related advantages.

### BRIEF SUMMARY OF THE INVENTION

In one embodiment, a reel-based mechanism for tightening footwear includes a tension member and a plurality of guide members that are positioned about an opening of the footwear and configured to guide or direct the tension member about a path along the footwear. The reel-based mechanism may further include a tightening mechanism that is operationally coupled with the tension member to effect tensioning of the tension member and tightening of the footwear upon operation of the tightening mechanism. The tightening mechanism may be configured to perform one or more secondary functions that are not related to tightening of the footwear.

Various aspects of the reel-based mechanism may include one or more of the following features. The tightening mechanism may include a knob member having one or more LED lights and the one or more secondary functions may include an LED beacon. The tightening mechanism may include a spool housing and a removable cover that is configured to be placed over the spool housing. The one or more LED beacons may be disposed on at least a portion of the spool housing. The tension member and the tightening mechanism may be separable from the plurality of guide members and securable to a pair of opposing handlebars disposed on opposing sides of a stretcher. The one or more secondary functions may include a restraint gurney. In another aspect, the tightening mechanism may include a knob member having a tape channel that is configured to secure a flexible ribbon therein, where the one or more secondary functions includes a tape measure. Other examples are possible.

### BRIEF DESCRIPTION OF THE DRAWINGS

FIG. 1 shows a perspective view of an example reel-based mechanism deployed on a shoe, according to various embodiments of the present invention;

FIG. 2 shows a close-up view of an example reel-based mechanism for tightening a shoe, according to various embodiments of the present invention;

FIG. 3 shows an exploded view of an example reel-based mechanism, according to various embodiments of the present invention;

FIG. 4 shows a bottom perspective exploded view of an example reel-based mechanism, according to various embodiments of the present invention;

FIG. 5 shows an example reel-based mechanism providing a tourniquet, according to various embodiments of the present invention;

FIG. 6 shows an example reel-based mechanism providing an LED beacon, according to various embodiments of the present invention;

FIG. 7 shows another example reel-based mechanism providing an LED beacon, according to various embodiments of the present invention;

FIG. 8 shows an example reel-based mechanism providing a patient restraint gurney, according to various embodiments of the present invention;

FIG. 9 shows an example reel-based mechanism providing a tape measure, according to various embodiments of the present invention;

FIG. 10 shows an example reel-based mechanism providing a container reel, according to various embodiments of the present invention;

FIG. 11 shows an example reel-based mechanism providing an avalanche beacon, according to various embodiments of the present invention;

FIG. 12 shows an example reel-based mechanism providing an additional tubing or lace reel, according to various embodiments of the present invention;

FIG. 13 shows an example reel-based mechanism providing a compass, according to various embodiments of the present invention;

FIG. 14 shows an example reel-based mechanism providing a mirror, according to various embodiments of the present invention;

FIG. 15 shows an example reel-based mechanism providing a harness, according to various embodiments of the present invention;

FIG. 16 shows an example reel-based mechanism providing an arm sling, according to various embodiments of the present invention;

FIG. 17 shows an example reel-based mechanism providing an overmold tourniquet, according to various embodiments of the present invention;

FIG. 18 shows an example reel-based mechanism an immobilizer, according to various embodiments of the present invention;

FIG. 19 shows an example reel-based mechanism providing a compress, according to various embodiments of the present invention;

FIG. 20 shows an example reel-based mechanism providing a jaws of life, according to various embodiments of the present invention;

FIG. 21 shows an example reel-based mechanism providing a cooking spit, according to various embodiments of the present invention;

FIG. 22 shows an example reel-based mechanism providing a dynamo, according to various embodiments of the present invention;

FIG. 23 shows an example reel-based mechanism providing a boot storage container, according to various embodiments of the present invention;

FIG. 24 shows an example reel-based mechanism providing a saw device, according to various embodiments of the present invention;

FIG. 25 shows an example reel-based mechanism providing a multi-purpose camp gear, according to various embodiments of the present invention; and

FIG. 26 shows an example reel-based mechanism providing a charcoal filter, according to various embodiments of the present invention.

### DETAILED DESCRIPTION OF THE DRAWINGS

Embodiments described herein provide various features for closure devices that that may be used to close and/or tighten a variety of items, such as shoes boots, or other footwear; medical or other braces (i.e., back braces, knee braces, and the like); items of clothing (i.e., hats, gloves, and the like) or other apparel; sports apparel (boots, snowboard boots, ski boots, and the like), and the like. In addition to closing and/or tightening items, the closure devices described herein may also be configured to provide various other functions and/or have other uses. A specific additional use of the closure devices may be related to aiding an individual in distress. For example, in emergency situations the closure device may be used for a purpose unrelated to tightening an object, such as a shoe. In such situations, the closure device may aid in survival of the individual, or render the situation less dangerous or hostile until help arrives. The closure device may even aid in hastening the time in which help will arrive. These and other uses of the closure device will be more apparent with respect to the figures that are described herein below.

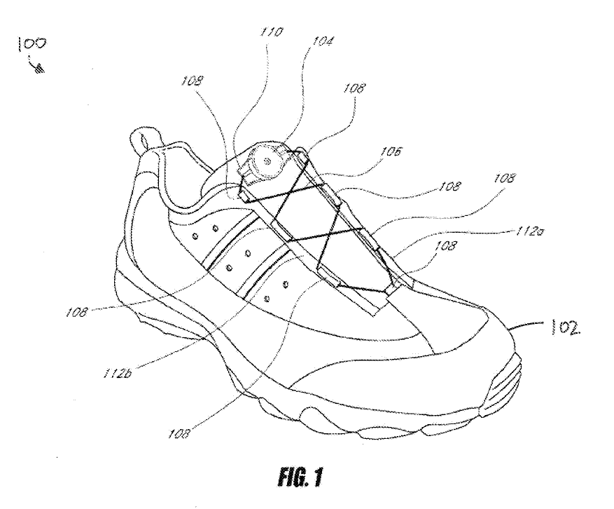

A general type of closure device involves a reel based mechanism having a knob that may be grasped and rotated by a user to wind a tension member (hereinafter lace) about a spool. The lace is typically positioned or guided about an article via one or more guide members that are positioned about the article. A specific use of such a reel based mechanism involves positioning the guide members along opposing eyestays across the shoe's tongue. The lace is positioned and guided across the shoe's tongue via the guide members. Rotation of the knob and tensioning of the lace causes the guide members and opposing eyestays of the shoe to be pulled toward one another, which effects tightening of the shoe about a user's foot. An exemplary reel based mechanism is illustrated in FIGS. 1-4. FIGS. 1-4 provide a general illustration of the components of a reel based mechanism and it should be realized that various other configurations and/or components are possible.

FIG. 1 is a perspective view of an embodiment of reel based mechanism 100 used for tightening a shoe 102. The shoe can be any suitable footwear that can be tightened around a wearer's foot. The reel based mechanism 100 can be used to close or tighten various other articles as described herein, such as, for example, a belt, a hat, a glove, snowboard bindings, a medical brace, or a bag. The reel based mechanism can include a reel assembly 104, a lace 106, and one or more lace guides 108. In the illustrated embodiment, the reel assembly 104 can be attached to the tongue 110 of the shoe. Various other configurations are also possible. For example, the reel assembly 104 can be attached to a side of the shoe 102, which can be advantageous for shoes in which the shoe sides 112a-b are designed to be drawn closely together when tightened leaving only a small portion of the tongue 110 exposed. The reel assembly 104 can also be attached to the back of the shoe 102, and a portion of the lace 106 can pass through the shoe 102, sometimes using tubing for the lace to travel through, on either side of the wearer's ankle such that the lace 106 can be engaged with the reel assembly 104 when back-mounted. In some embodiments, the reel assembly 104 may also be attached to the lateral side at or near the top of the lacing throat.

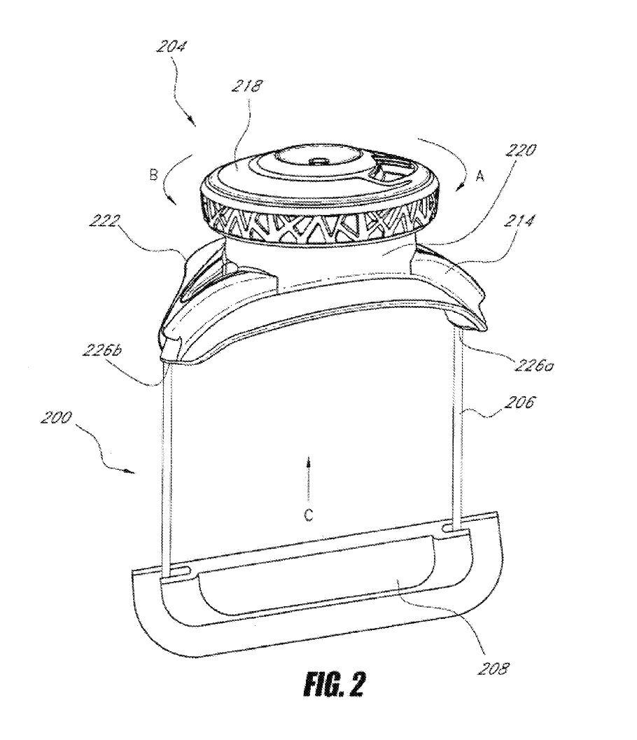

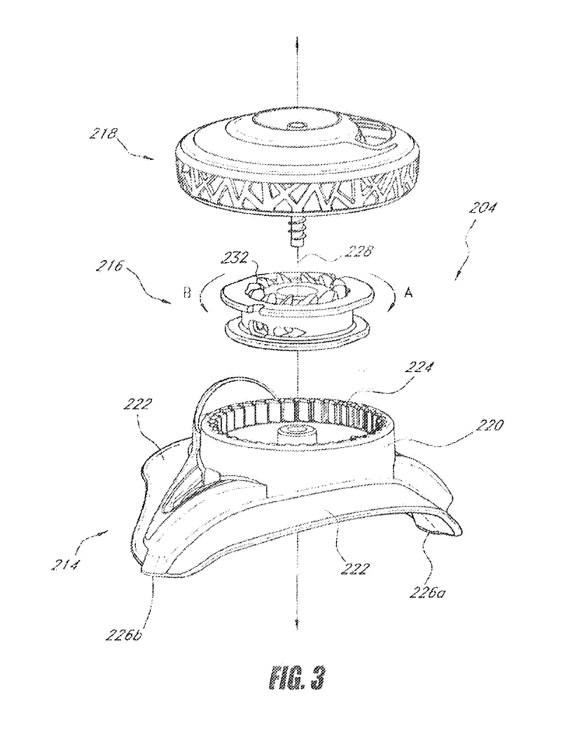

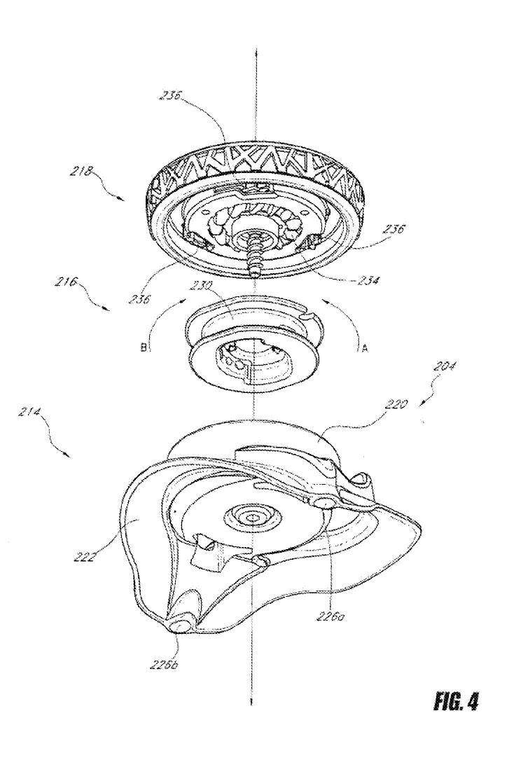

FIG. 2 is a perspective view of a reel based mechanism 200 that can be similar to reel based mechanism 100, or any other reel based mechanism described herein. The reel based mechanism can include a reel assembly 204 which can be similar to the reel assembly 104, or any other reel/knob assembly. FIG. 3 is an exploded perspective view of the reel assembly 204. FIG. 4 is another exploded perspective view of the reel assembly 204.

With reference to FIGS. 2 to 4, the reel assembly 204 can include a base member 214, a spool member 216, and a knob member 218. The base member can include a housing 220 and a mounting flange 222. The spool housing 220 can include a plurality of ratchet teeth 224, which can extend radially inwardly. The base member 214 can include lace holes (e.g., 226a) that allow the lace 206 to enter the spool housing 220.

The spool member 216 can be disposed within the spool housing 220 such that the spool member 216 is rotatable about an axis 228 with respect to the spool housing 220. The lace 206 can be secured to the spool member 216 such that when the spool member 216 rotates in a tightening direction (shown by arrow A) the lace 206 is drawn into the spool housing 220 and is wound around the channel 230 formed in the spool member 216, and when the spool member 216 rotates in a loosening direction (shown by arrow B) the lace 206 unwinds from the channel 230 of the spool member 216 and exits the spool housing 220 via the lace holes (e.g., 226a). The spool member 216 can also include spool teeth 232 formed thereon. It will be understood that the embodiments disclosed herein can be modified such that rotation in the direction shown by arrow B will tighten the lacing. In this particular embodiment, the knob member 218 may be raised axially to disengage from spool 216 to allow the spool 216 to freewheel in direction B in order to release the lace. In other embodiments, rotation of the knob member 218 in the direction shown by arrow A may loosen the reel based mechanism. In a specific embodiment, the knob member 218 may be rotated a specific amount (e.g., ¼ to ½ turn) in a loosening direction (e.g., as shown by arrow A) to loosen the reel based mechanism. Other user interfaces are possible for tightening, releasing, or adjusting lace tension.

The knob member 218 can be attached to the spool housing 220 such that the knob member 218 can rotate about the axis 228 with respect to the spool housing 220. The knob member 218 can include knob teeth 234 that can be configured to mate with the spool teeth 232 to couple the knob member 218 to the spool member 216 such that rotation of the knob member 218 in the tightening direction causes the spool member 216 to also rotate in the tightening direction. In some embodiments, the rotation of the knob member 218 in the loosening direction can also cause the spool member 216 to rotate in the loosening direction. The knob member 218 can also include one or more pawls 236 which can be biased radially outwardly so as to mate with the ratchet teeth 224. The pawls 236 and ratchet teeth 224 can be configured so that the ratchet teeth 224 can displace the pawls 236 radially inwardly when the knob member 218 is rotated in the tightening direction, thereby allowing the knob member 218 to rotate in the tightening direction. The pawls 236 and the ratchet teeth 224 can also be configured so that they engage one another when force is applied to twist the knob member 218 in the loosening direction, thereby preventing the knob member 218 from rotating in the loosening direction. In other arrangements, the ratchet teeth 224 may be oriented axially to engage knob pawl members (not shown) that are correspondingly arranged to mate axially.

Thus, a reel assembly such as reel assembly 204 can provide a one-way tightening system configured to allow the user to rotate the knob member 218 in the tightening direction, which causes the spool member 216 to rotate in the tightening direction, which in turn causes the lace 206 to be drawn into the spool housing 220 via the lace holes (e.g., 226a). As the lace 206 is drawn into the spool housing 220 the reel based mechanism 200 can tighten, causing the lace guide 208 to be drawn in the direction toward the reel assembly 204 (shown by arrow C in FIG. 2). Although the reel based mechanism 200 is shown with a single lace guide 208, any other suitable number of lace guides can be used. Other features of the reel and reel based mechanism are described in U.S. Patent Application No. 2011/0266384, filed Apr. 29, 2011, and Titled “Reel Based Lacing System”, the entire disclosure of which is incorporated herein by reference.

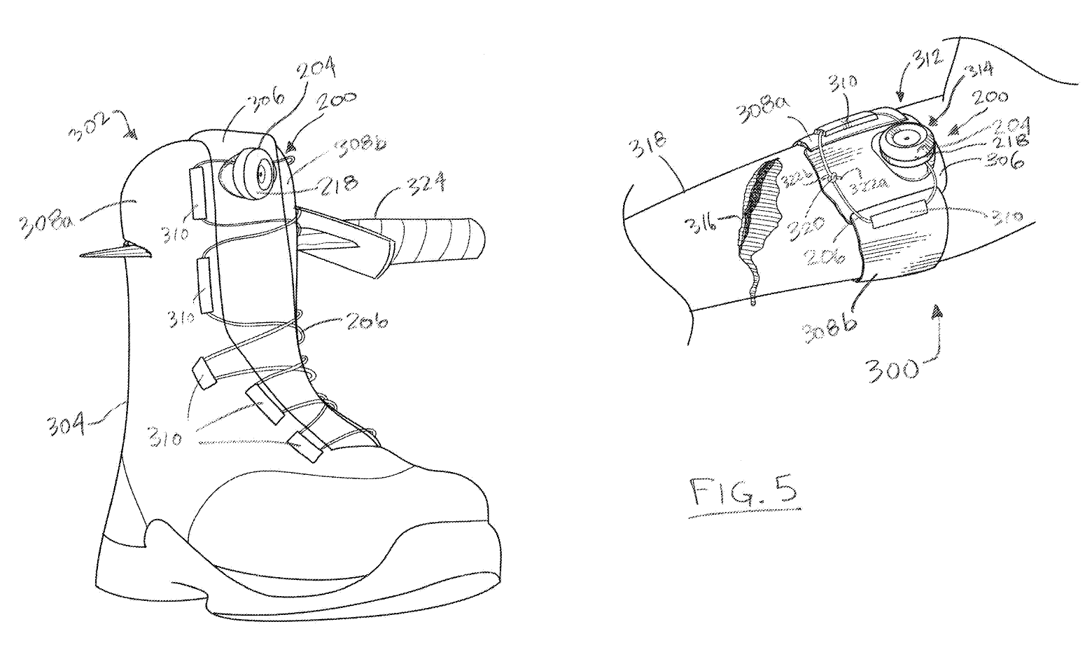

As described above, it may be desired to use the reel based mechanism 100,200 for various other functions in addition to closing and/or tightening an item, such as to aid an individual in distress, aid in hastening help or rescue, aiding in surviving a dangerous situation, aid in an emergency situation, and the like. FIGS. 5-26, which are described herein below, illustrate various additional uses of the reel based mechanism 200, which may also be provided by the reel based mechanism 100. Other embodiments are possible.

FIG. 5 shows the reel-based mechanism 200 functioning as a tourniquet 300. The tourniquet 300 may be provided by removing portions of the reel-based mechanism 200 and an upper portion 302 of a shoe 304 with a cutting tool. The upper portion 302 of the shoe 304 may include portions of a tongue 306, shoe sides 308a,b, and one or more pairs of guides 310. In this way, the upper portion 302 may provide a band 312 of the tourniquet 300. The reel assembly mechanism 200, more particularly the reel assembly 204 and portions of the lace 206, functions as a tightening mechanism 314 of the tourniquet 300. Together, the band 312 and the tightening mechanism 314 form the tourniquet 300 that may function as a constricting band to stop or otherwise control bleeding from a wound 316 on an arm 318 or a leg compressed therethrough. For instance, as shown in FIG. 5, the arm 318 of a user may be inserted through the tourniquet 300. A knot 320 may be formed by tying open ends 322a,b of the lace 206. The knob member 218 may be rotated in a direction that draws the pair of guides 310 together and tightens the band 312 around the arm 318. In this way, the tourniquet 300 may be used to secure and compress the arm 318 to control bleeding at the wound 316. Further, the tourniquet 300 may be loosened and/or removed from the arm 318 by turning the knob member 218 in an a direction that releases tension of the lace 206. In another aspect, the band 312 of the tourniquet 300 may be sized by cutting more or less of the shoe 304 with a cutting tool 324, e.g. forming a wider band having more than one pair of guides 310. Further, it is contemplated that the tightening mechanism 314 may be used with any type of band to provide functions of the tourniquet 300.

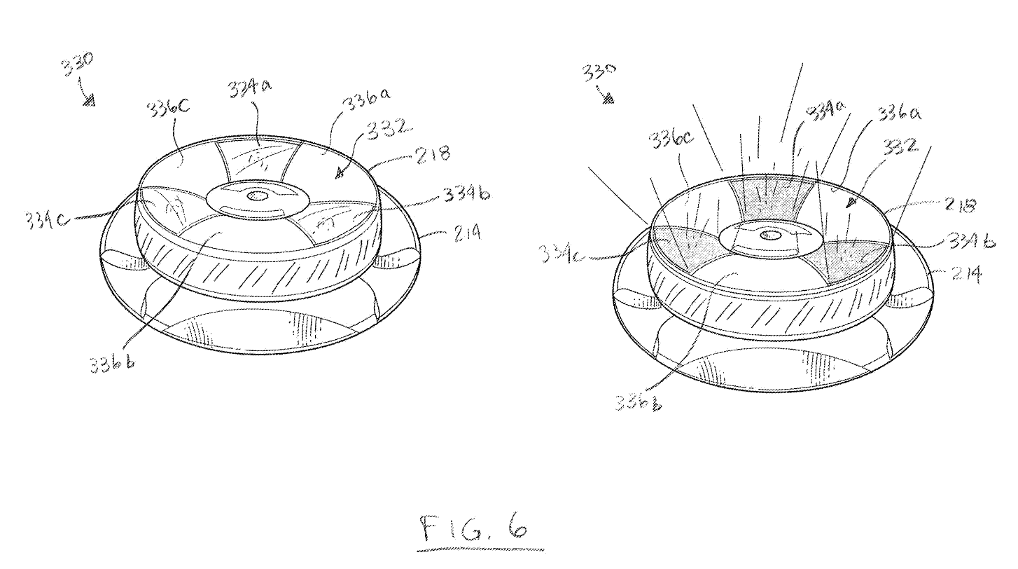

FIG. 6 shows components of the reel-based mechanism 200 functioning as a LED beacon 330. More particularly, FIG. 6 shows the knob member 218 operatively attached to the base member 214. An upper surface 332 of the knob member 218 may provide one or more lighting means, such as three spaced-apart LED lights 334a,b,c. The LED lights 334a,b,c may emit light upon activation, which may include, merely by way of example, turning the knob member 218 relative to the base member 214 to complete an electrical circuit, pushing down on the knob member 218 or a portion of the knob member 218, and the like. The LED lights 334a,b,c may be powered by a battery (not shown) housed within the knob member 218, on the base member 214, and/or in operative connection with a battery source (not shown) located remotely, such as on other portions of the shoe 304 or components of the reel-based mechanism 200. In another aspect, the knob member 218 and/or base member 214 may provide one or more solar panels, such as panels 336a,b,c for collecting solar energy, which may be stored in a battery (not shown) in communication with the LED lights 334a,b,c. Further, it is contemplated that the LED lights 334a,b,c may be red, green, yellow, white, and/or any color or a combination of different colors. In another aspect, the LED beacon 330 may have various blinking and/or non-blinking patterns that can be selected by pressing down on or rotating the knob member 218. In yet another aspect, the base 214 may be attached to an additional base and/or comprise attachment means (not shown) to secure the LED beacon 330 to an attachment surface. Such attachment means may include, merely by way of example, Velcro, magnets, string, channels for receiving protrusions, protrusions, screws, and the like. In another aspect, the lace 206 (see FIG. 5) may be utilized to secure the LED beacon 330 to the attachment surface.

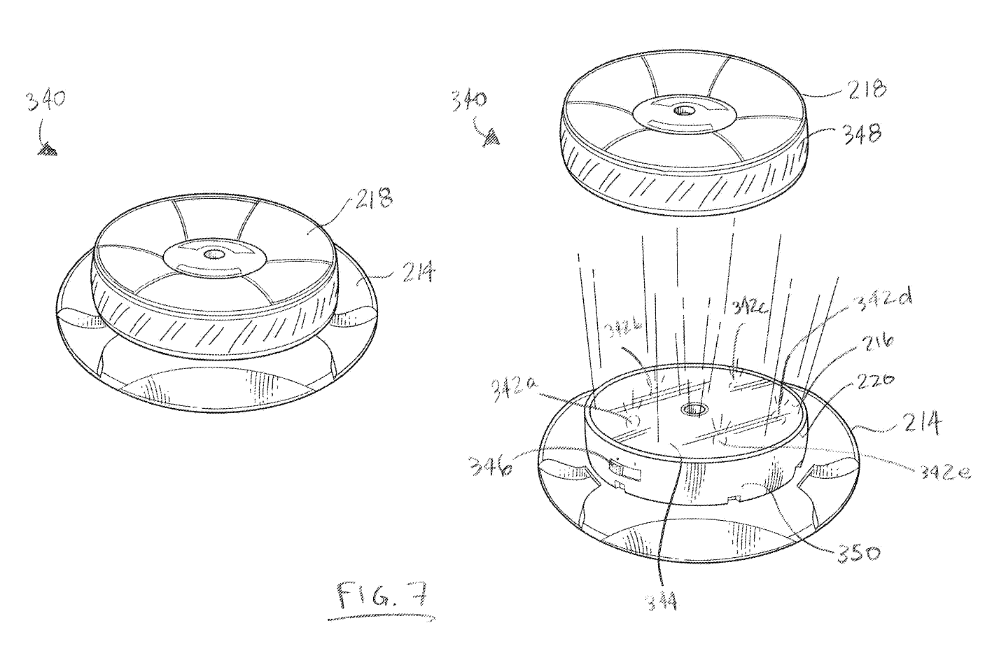

FIG. 7 shows further aspects of the reel-based mechanism 200 functioning as a LED beacon 340. The LED beacon 340 may be similar to the LED beacon 330 of FIG. 6, and/or include features, additionally or alternatively, to the LED beacon 330. The knob member 218 is operatively and removably attached to the base member 214. Removing the knob member 218 reveals one or more lighting devices, e.g. LED lights 342a-e, disposed on the base member 214, such as within the spool housing 220 of the base member 214. A transparent cover 344 may be provided on the spool housing 220 over the LED lights 342a-e for protection against water, debris, or other elements. For instance, the LED beacon 340 may be waterproof. In another example, an exposed surface of the spool member 216 comprises the transparent cover 344 that overlays the LED lights 342a-e disposed on the spool member 216. The LED lights 342a-e may be activated by an on/off switch 346, which may be disposed on the base member 214, such as on an outer side 350 of the spool housing 220. The on/off switch 346 and LED lights 342a-e may be concealed by the knob member 218 and revealed or otherwise accessed upon removal of the knob member 218. The knob member 218 may be friction-fit, latched, and/or rotatably secured to the base member 214 or spool housing 220. In another aspect, an inner surface of the sidewall 348 of the knob member 218 may be configured to magnetically attach to the sidewall 350 defining the spool housing 220. It is contemplated that the LED lights 342a-e may be turned on yet concealed entirely from emitting light out of the reel-based mechanism 200 when the knob member 218 is placed on the base member 214. In other examples, the knob member 218 may subdue the emitted light, and/or portions of the knob member 218 may be transparent or opaque to reveal or block light.

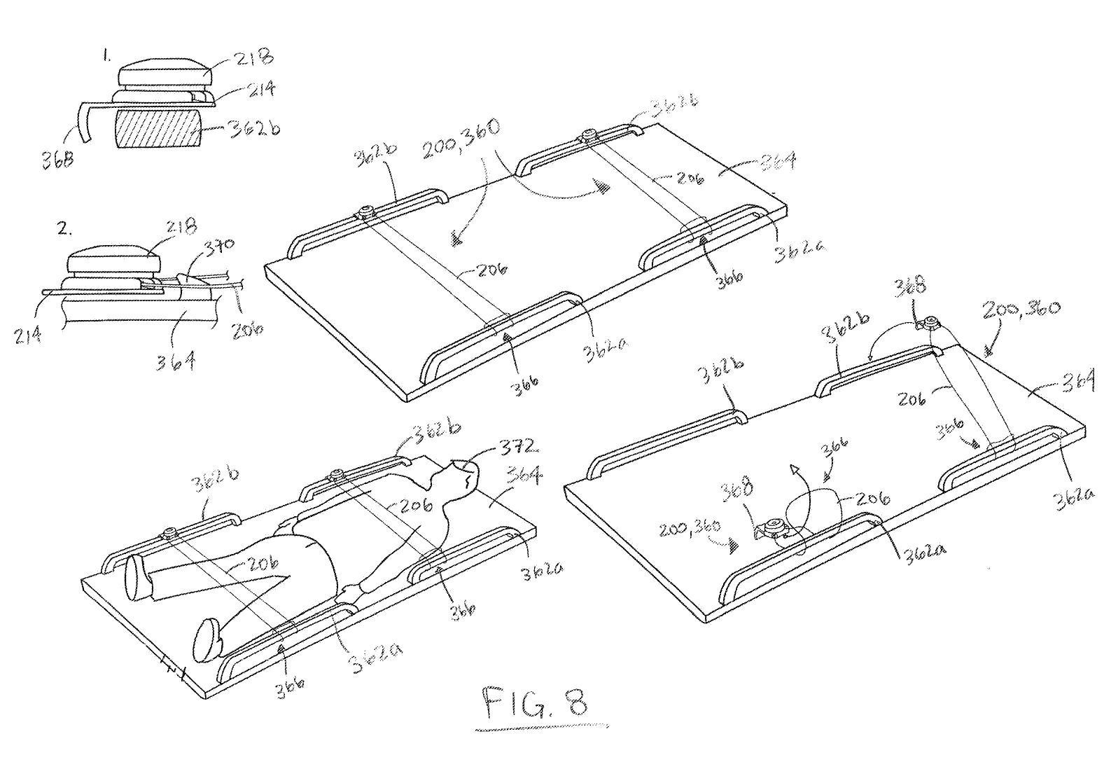

FIG. 8 shows components of the reel-based mechanism 200 functioning as a patient restraint gurney 360. For instance, the reel-based mechanism 200 may be removed from the shoe 304 (see FIG. 5) and secured to a pair of opposing handlebars 362a,b disposed on opposing sides of a stretcher 364. More particularly, the lace 206 may be secured to a first handlebar 362a by a Prusik knot 366, loop, or other type of knot. The reel assembly 204 may be hooked or otherwise secured to the opposing handlebar 362b. For instance, in one example, the base member 214 of the reel assembly 204 may provide a hook 368 that latches onto the opposing handlebar 362b. In a different example, the lace 206 may be used to wrap around the opposing handlebar 362b, and/or a protrusion 370 on the stretcher 364, such that portions of the base member 214 and/or the knob member 218 directly abut against the protrusion 370. The knob member 218 may be dialed to tighten and/or loosen the lace 206 across a patient 372 to ensure that the patient 372 is secured to the stretcher 364. As shown in FIG. 8, two patient restraint gurneys 360 are provided by two reel-based mechanisms 200 secured to two pairs of handlebars disposed on the stretcher 364.

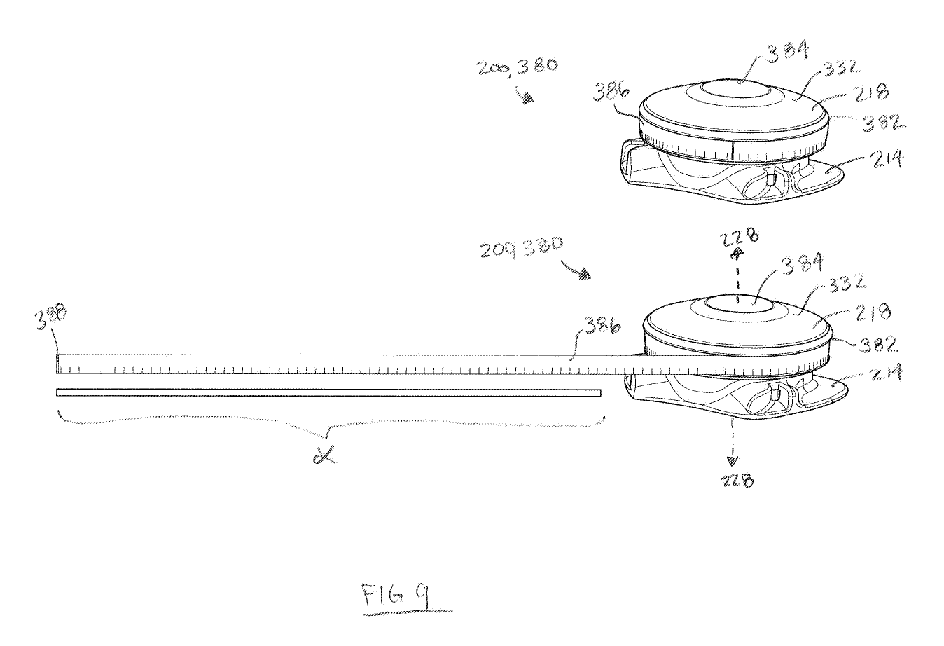

FIG. 9 shows components of the reel-based mechanism 200 functioning as a tape measure 380. The knob member 218 may have a tape channel 382 defining a cylindrical sidewall of the knob member 218 and the upper surface 332 of the knob member 218 may have a depressible release button 384 disposed centrally thereon. A flexible ribbon 386 having measurement markings may be wound about the tape channel 382. An end 388 of the ribbon 386 may be pulled away from the reel-based mechanism 200 to unwind the ribbon 386 when surveying a length L. It is contemplated that unwinding the ribbon 386 causes the knob member 218 to rotate relative to the base member 214 about the axis 228. In another aspect, the tape channel 382 may rotate relative to the remainder of the knob member 218, e.g. relative to the upper surface 332 and/or the depressible release button 384. The tape measure 380 may lock the ribbon 386 so that the ribbon 386 does not automatically retract and wind about the tape channel 382 when the end 388 is released by a user. After measuring the length L, depression of the release button 384 may cause the knob member 218, or portions thereof, to spin about the axis 228 in a direction that winds the ribbon 386 back around the tape channel 382.

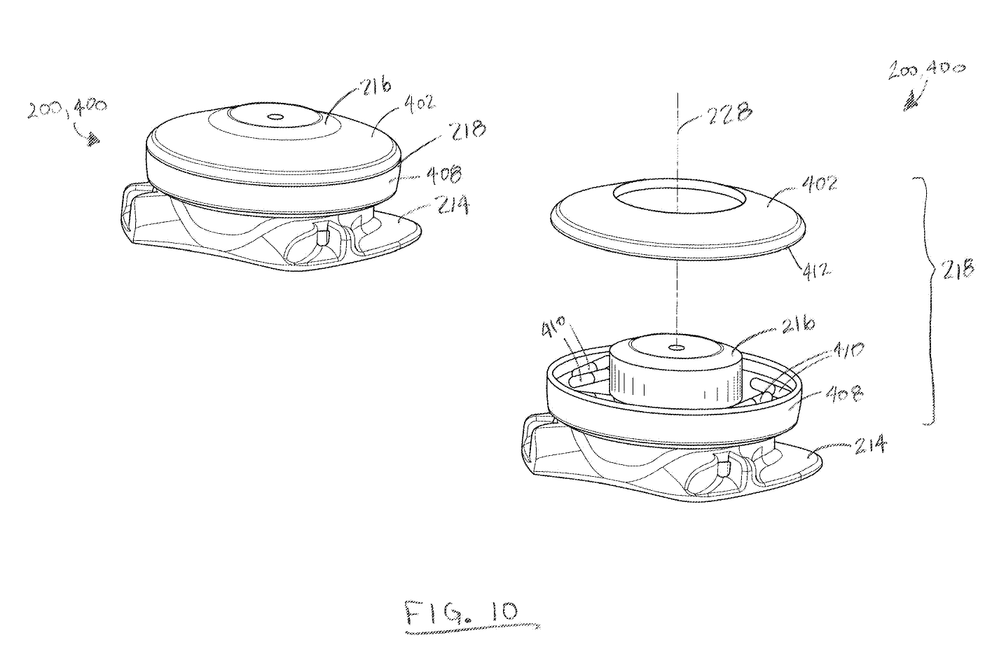

FIG. 10 shows components of the reel-based mechanism 200 functioning as a container reel 400. The knob member 218 includes a removable cap 402 that can be snapped-on, hinged, hooked, magnetically-attracted, and/or rotationally secured onto a cylindrical housing 404. A centrally-disposed circular orifice 406 may be provided on the cap 402 to expose portions of the spool member 216 therethrough. A hollow space 408 defined between the spool member 216 and an inner wall of the cylindrical housing 404 may be generally donut-shaped and configured to receive pills 410 and/or any other objects. An outer edge 412 of the removable cap 402 may be press-fit onto the cylindrical housing 404, be hinged onto the cylindrical housing 404, and/or have threads corresponding to threads provided on the cylindrical housing 404. In one aspect, a seal may be provided between the removable cap 402 and the body defining the hollow space 408 to provide a watertight and/or leakage-proof container.

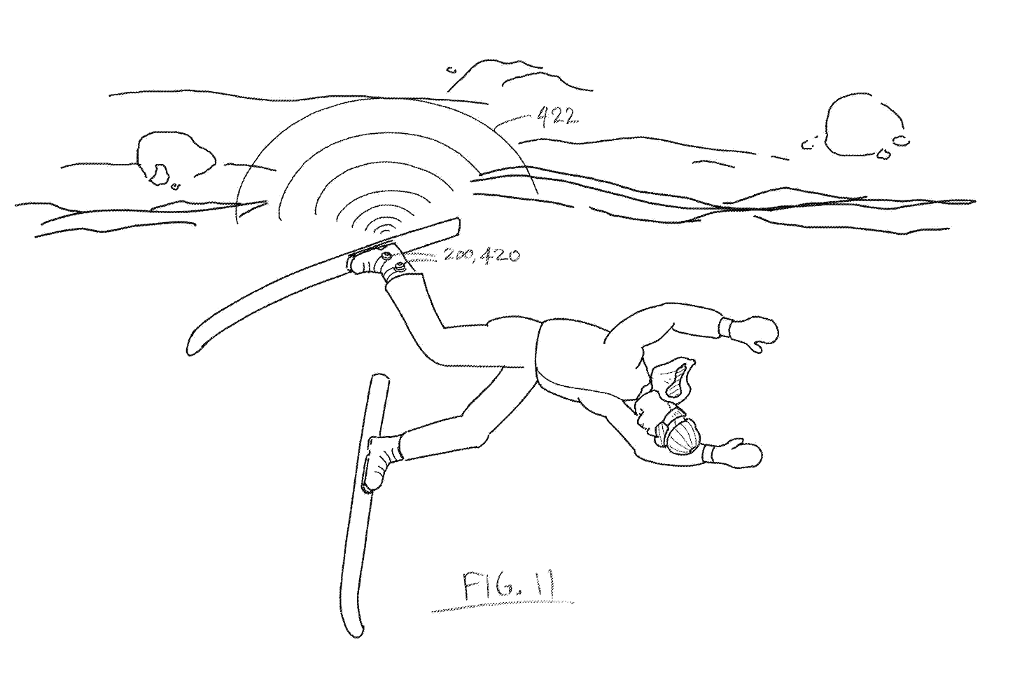

FIG. 11 shows components of the reel-based mechanism 200 functioning as an avalanche beacon 420 and/or any other distress signal output device. The avalanche beacon 420 may have a sensor (not shown) for sensing threshold conditions and/or a signal emitter for emitting a distress signal 422 when the sensor detects an emergency situation. Merely by way of example, the distress signal 422 may be one or more of a distress sound signal, light signal, radio wave signal, GPS location signal, signal transferring data related to a user and/or situation, and the like. The sensor may comprise one or more of a variety of sensors, such as, and merely by way of example, an accelerometer for detecting threshold accelerations, temperature sensor, heat sensor, humidity sensor, sound sensor, and/or GPS sensor for detecting if the user is located within a boundary. In another aspect, the avalanche beacon 420 may be activated to emit the distress signal 422 by a voice command and/or manual depression or other input from the user. In a further aspect, the avalanche beacon 420 may comprise a radio transceiver that sends the distress signal 422 as radio waves and receives signals from a remotely located, different transceiver. It is contemplated that the avalanche beacon 420 may aid in locating the user, or equipment attached thereto, which may be buried under snow.

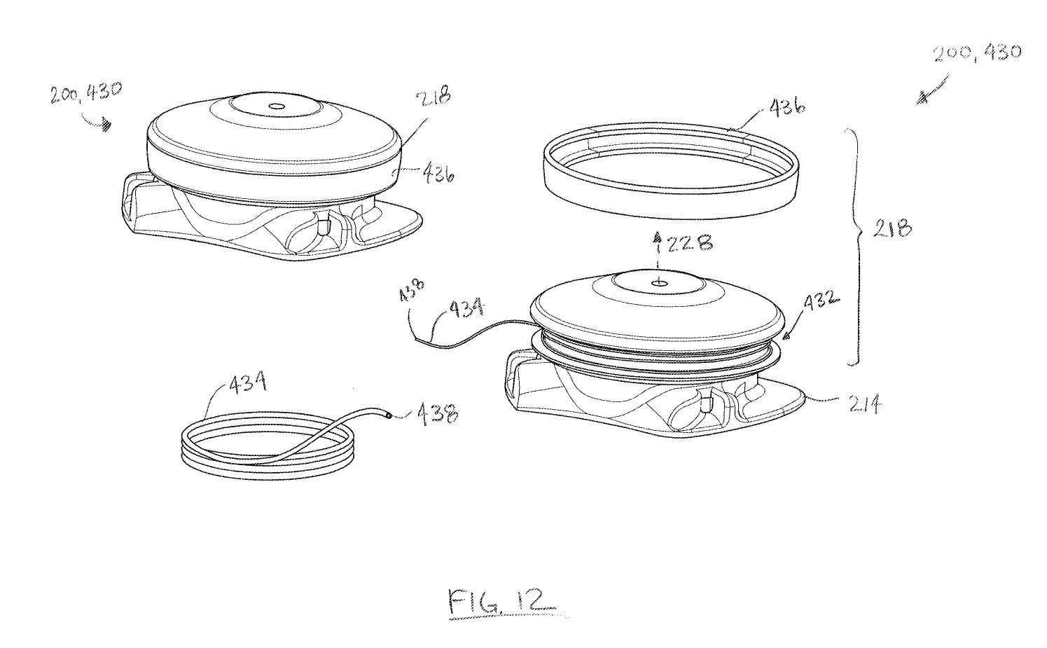

FIG. 12 shows components of the reel-based mechanism 200 functioning as an extra tubing or lace reel 430. The lace reel 430 may be disposed on the knob member 218 and define a lace channel 432 about a perimeter of the knob member 218. The lace channel 432 may be configured to secure an extra lace or tubing 434 that is wound about the channel 432. The channel 432 may be covered by a removable overmold or ring 436 when not in use. It is contemplated that pulling on an end 438 of the extra tubing 434 and/or turning the lace reel 430 in one direction may unwind the extra tubing 434 from the lace channel 432, and turning the lace reel 430 in an opposite direction may wind the tubing 434 back into the channel 432. The lace reel 430 may rotate about the rotational axis 228. In some examples, it is contemplated that the rotation of the lace reel 430 may be adjusted to be independent of the rotation of the spool member 216, which rotates about the same axis 228. In another aspect, the lace reel 430 may include features, alternatively or in addition to, that are described in regarding the tape measure 380 (see FIG. 9).

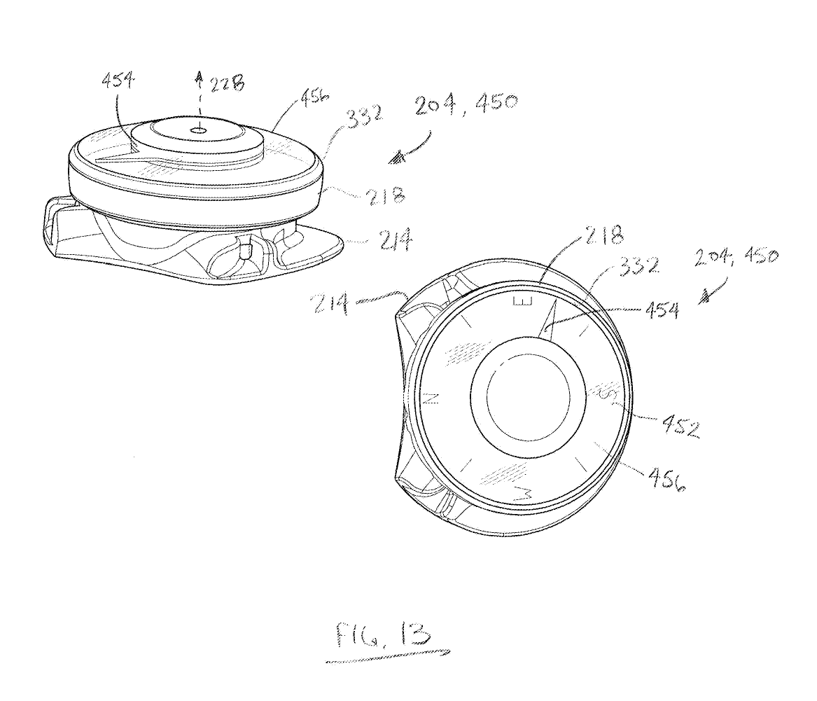

FIG. 13 shows components of the reel-based mechanism 200 functioning as a compass 450. More particularly, the upper surface 332 of the knob member 218 may provide the compass 450 having a directional measurement face 452, a rotating needle 454, and a transparent cover 456. The rotating needle 454 may rotate freely and generally frictionlessly about the axis 228 to align with and point toward north. In practice, a user may remove the reel-based mechanism 200 from the shoe 304 and rest the base member 214 flat on the user's palm with the upper surface 332 facing upward. In another aspect, the base member 214 may contain adhesive or other securing mechanisms for attaching the compass 450 to an attachment surface. Still, in another aspect, the lace 206 (see FIG. 2) may further provide an adjustable-length necklace for the user to wear the compass 450 around the neck.

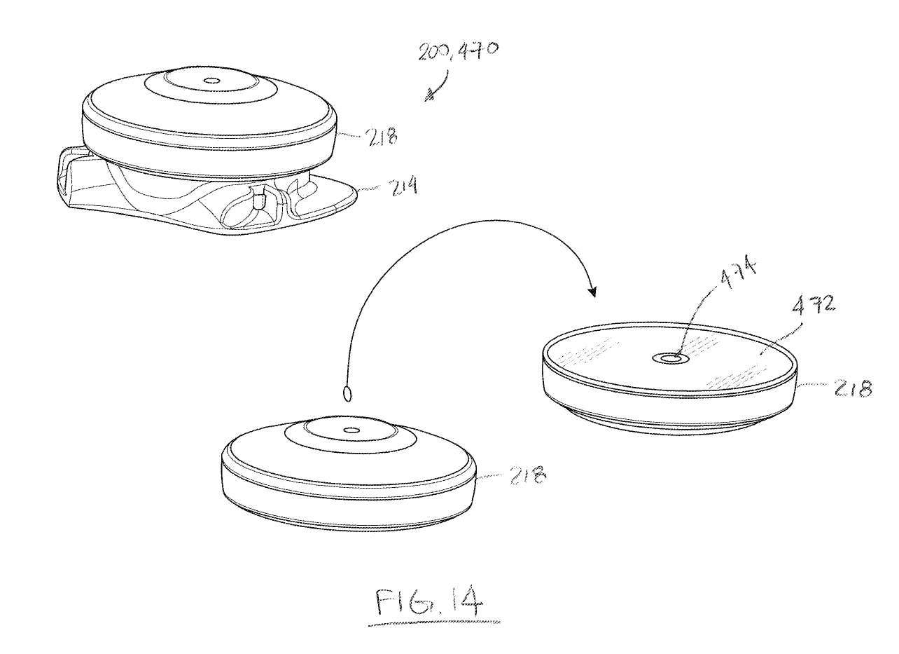

FIG. 14 shows components of the reel-based mechanism 200 functioning as a mirror 470. For instance, an underside of the knob member 218 may have a reflective pane 472, e.g. mirror, that is accessible by removing the knob member 218 from the base member 218. The knob member 218 may be removably attached to the base member 214 by a central slot 474 that is adapted to receive a protruding knob (not shown) disposed centrally on the base member 214. In practice, the mirror 470 may be used as a fire starter, among other possible implementations. In yet another example, a removable cover (not shown) may be provided parallel to the reflective pane 472 to protect the reflective pane 472 from scratches. Still, other examples are possible.

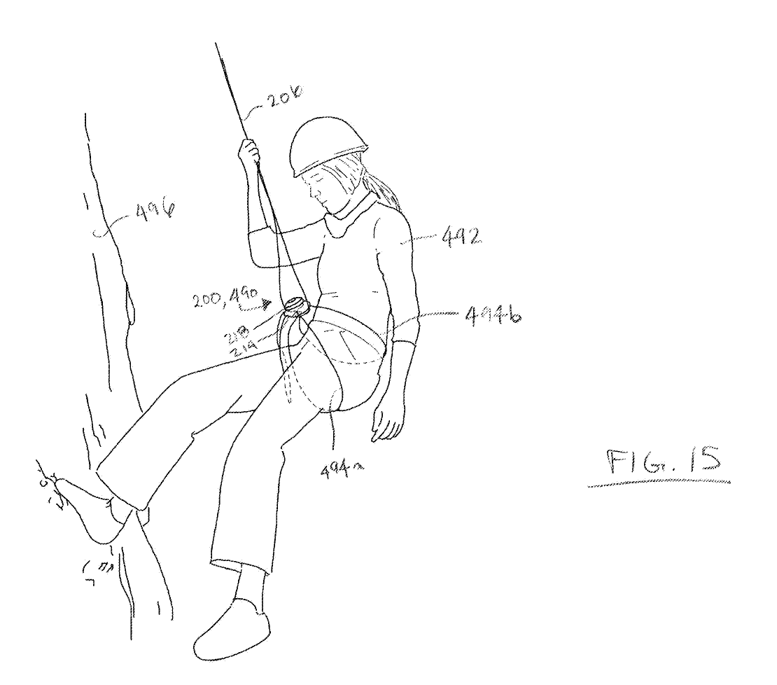

FIG. 15 shows components of the reel-based mechanism 200 functioning as a harness 490, e.g. a rescue harness. For instance, the lace 206 may be wrapped multiple times around a user 492, and/or the lace 206 may provide two loops 494a,b that are looped around the user 492 to rappell the user 492 down along a mountainside 496 or other vertical surface that may require a roped descent. It is contemplated that turning the knob member 218 may tighten or loosen the harness 490, e.g. loops 494a,b, around the user 492. In another aspect, rotating the knob member 218 may lower and/or raise the user 492 along the mountainside 494. Further, in yet another aspect, the reel-based mechanism 200 may be configured to secure an additional rope (not shown) that may further guide the user 492 down the mountainside 496.

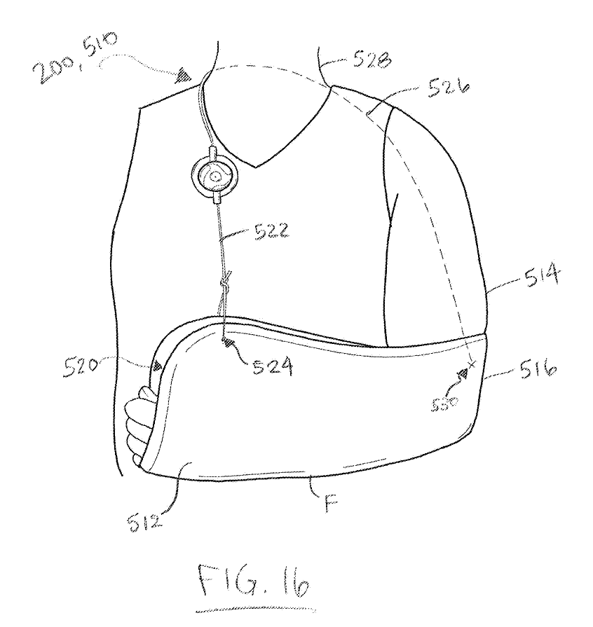

FIG. 16 shows components of the reel-based mechanism 200 functioning as an arm sling 510. The arm sling 510 may comprise the knob member 218, a portion of the lace 206, and an envelope 512. In one example, the base member 214 may remain attached to the knob member 218. The envelope 512 may comprise a piece of cloth, poly, netting, or other flexible material that may be folded in half along a foldline F to receive a user's arm 514 therein. In one example, the envelope 512 defines a closed end 516 for supporting the user's elbow and an opposing open end 518 that reveals the user's hand 520. In practice, a first portion 522 of the lace 206 may be received through one or more first holes 524 and tied with a first knot 526. Merely by way of example, a pair of first holes 524 may be provided on opposing surfaces of the envelope 512 near the open end 518. A second portion 526 of the lace 206 may be draped around a back of the user's neck 528 and knotted or otherwise secured to a second hole 530 provided on the envelope 512 near the closed end 516. As shown in FIG. 16, the second hole 530 may be positioned behind the user's arm 514. In practice, it is contemplated that the knob member 218 may be turned to adjust a length of the first and second portions 522, 526 of the lace 206 to adjust a comfort and height of the envelope 512.

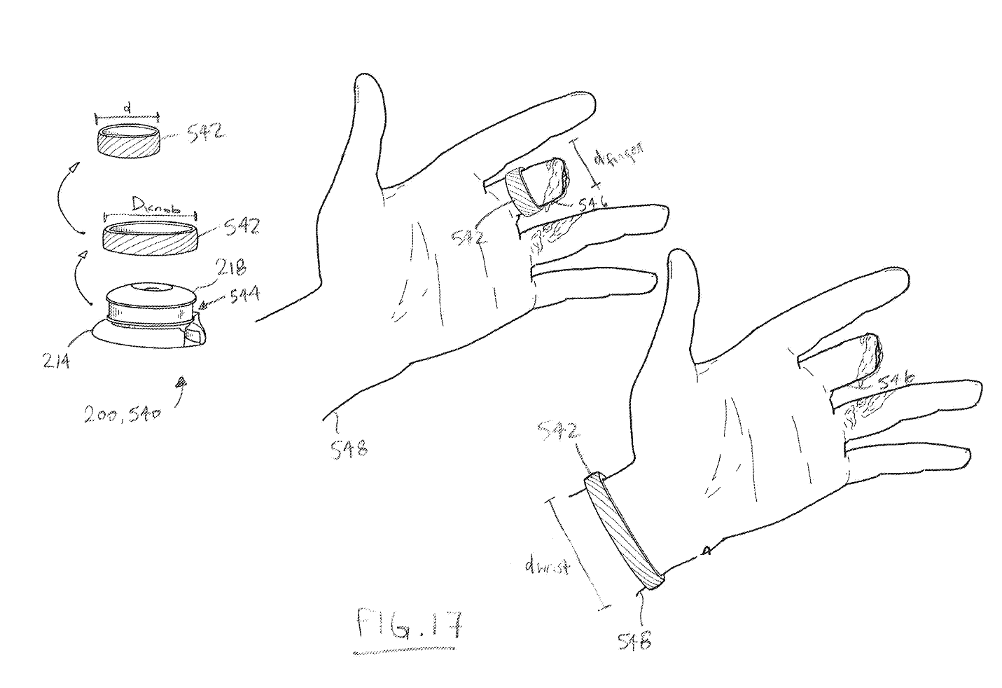

FIG. 17 shows components of the reel-based mechanism 200 functioning as an overmold tourniquet 540. The overmold tourniquet 540 may be provided as a removable, elastic ring 542 disposed around a cylindrical portion or channel 544 of the knob member 218. In an unremoved position, the elastic ring 542 may be stretched about the overmold tourniquet 540 to define an approximate knob member diameter D_{Knob}. In a relaxed or less-stretched position, the elastic ring 542 may define a smaller diameter d. A benefit of the elastic ring 542 is that the elastic ring 542 may accommodate a variety of sizes for a variety of different applications and provide pressure for controlling bloodflow through a variety of body parts inserted through the elastic ring 542. For instance, the elastic ring 542 may define a diameter d_{finger} for securing around a wounded finger 546 and controlling or minimizing loss of blood through the finger 546. In another example, the same elastic ring 542 may be stretched to define a diameter d_{wrist} for securing about the user's wrist 548 to control bloodflow to the wounded finger 546. Still, other diameters are possible. It is contemplated that the reel-based mechanism 200 may still provide other functions even with the elastic ring 542 removed. In some embodiments, the elastic ring 542 is a rectangular and flat strip of rubber forming a circle. Further, it is contemplated that the channel 544 may receive a plurality of elastic rings 542.

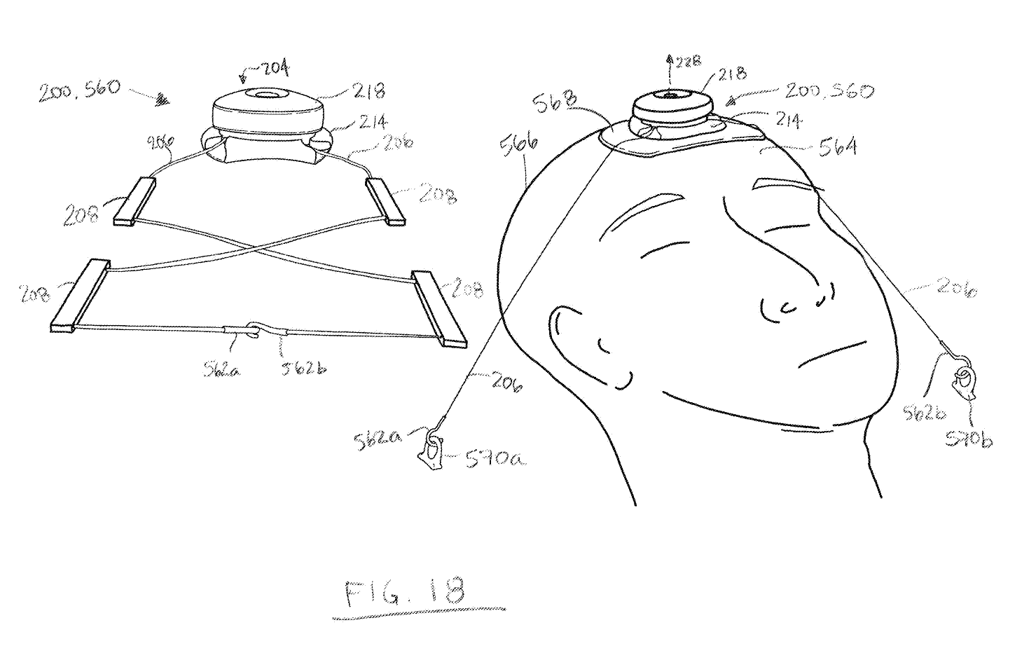

FIG. 18 shows components of the reel-based mechanism 200 functioning as an immobilizer 560. In one example, the reel-based mechanism 200 includes the knob member 218 attached to the base member 214, whereby the knob member 218 is operatively coupled to the lace 206 having a pair of hooked ends 562a,b or other coupling components. When deployed on the shoe 304, the lace 206 may pass through a plurality of guides 208 disposed on the shoe 304 as previously described and form a closed loop by engaging the pair of hooked ends 562a,b together at a distal end from the reel assembly 204. The hooked ends 562a,b may be unhooked or otherwise disengaged to remove the reel-based mechanism 200 from the plurality of guides 208 and placed on a forehead 564 or other portion of the patient's head 566. In some embodiments, a pad 568 of cloth, plastic, or other piece of material may be provided between the base member 214 and the forehead 564 for comfort. In that case, an attachment mechanism may be provided between the base member 214 and the pad 568 to secure the two components together. The pair of hooked ends 562a,b may be hooked or otherwise engaged to a pair of rings 570a,b or other receptors, which may be disposed on a stretcher. Turning the knob member 218 in a tightening direction about the axis 228 may increase tension of the lace 206 at both sides of the patient's head 566 to further securitize the patient's head 566 against a surface and prevent movement or bouncing of the patient's head 566 during transport. Turning the knob 218 in an opposing direction may loosen the tension of the lace 206 and/or allow disengagement of the hooked ends 562a,b from the pair of rings 570a,b.

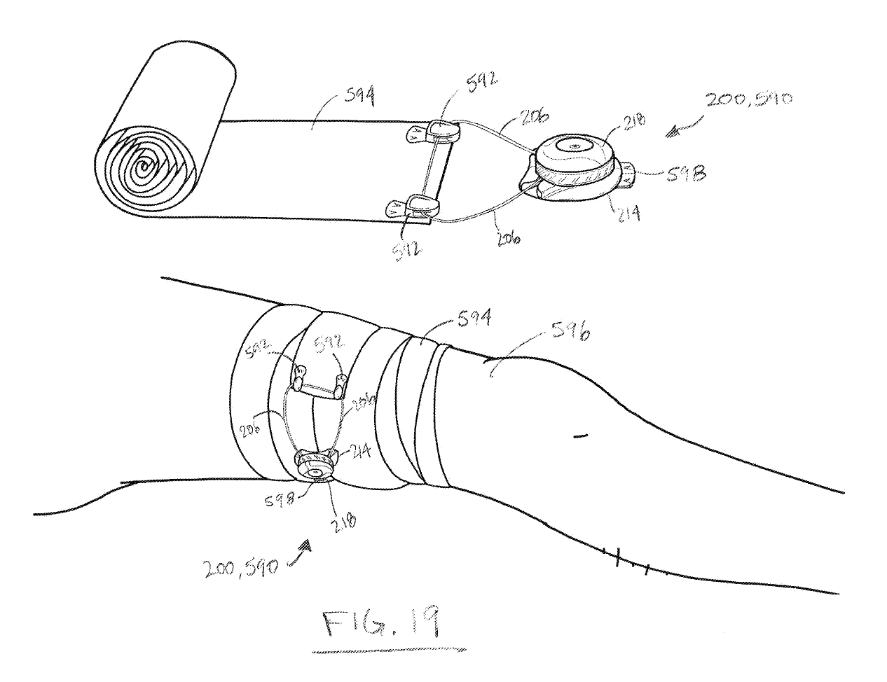

FIG. 19 shows components of the reel-based mechanism 200 functioning as a compress 590. More particularly, the lace 206 may pass through one or more clasps 592 disposed on an end of a compression wrap 594. The lace 206 may be tied or otherwise form a closed loop to operatively attach the clasps 592 with the knob member 218 disposed on the base member 214. In one example, the compression wrap 594 may be stretched and/or wrapped around a user's appendage, e.g. leg 596. The compression wrap 594 may be secured to the user's leg 596 by securing means disposed on an underside of the base member 214 to engage a portion of the compression wrap 594. In one example, the securing means comprises removable clips 598 that hook into the compression wrap 594. In another example, the securing means may comprise adhesive backing, Velcro, and/or other clips configured to hook into corresponding metal clips that are disposed on the compression wrap. In practice, it is contemplated that the compression wrap 594 may be further tightened (or loosened) about the user's leg 596 by turning the knob member 218 to retract (or release) portions of the lace 206. In this way, the compress 590 may be adjusted without having to remove the compress 590 entirely from the user's leg 596.

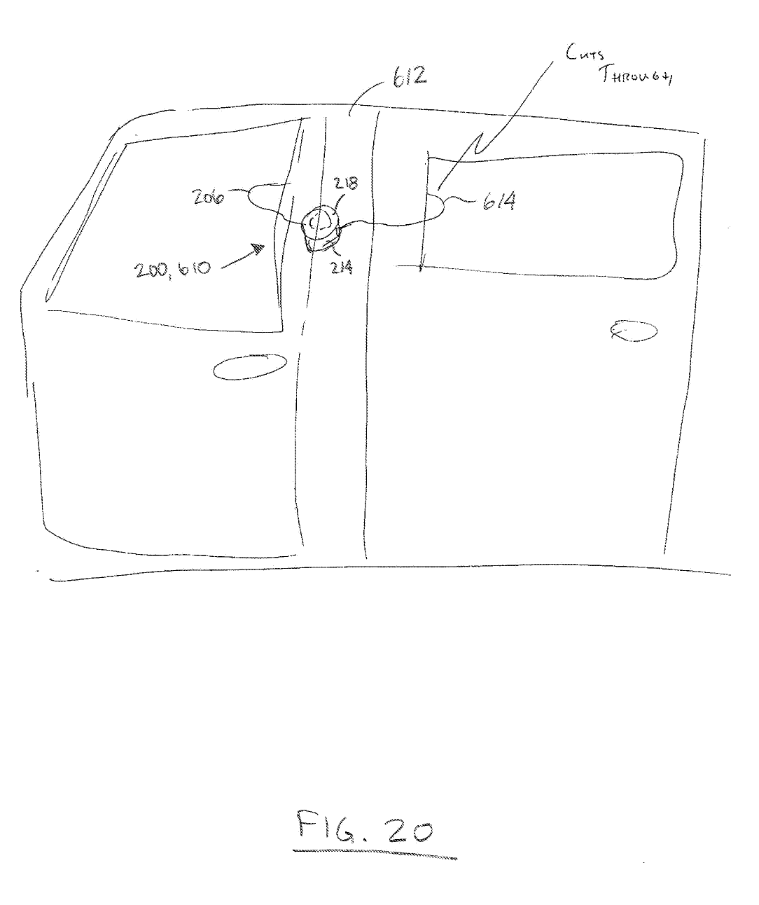

FIG. 20 shows components of the reel-based mechanism 200 functioning as a jaws of life 610. The jaws of life 610 may utilize the lace 206, and/or a different cord inserted into the knob member 218, to cut through an object, which may be useful in an extraction and rescue mission. Merely by way of example, the lace 206 may be wrapped around a portion of an object, such as a car 612, and knotted or otherwise manipulated to form a closed loop 614 around the object. The knob member 218 may be manually rotated to decrease the size of the closed loop 614, thereby cutting into the object. In one example, a user may rotate the knob member 218 until the lace 206 completely cuts through the object or a portion thereof, which allows for extraction of a person and/or object. In a different aspect, the jaws of life 610 may be used to secure around heavy object and couple the heavy object to a crane or other lifting device which may lift the object.

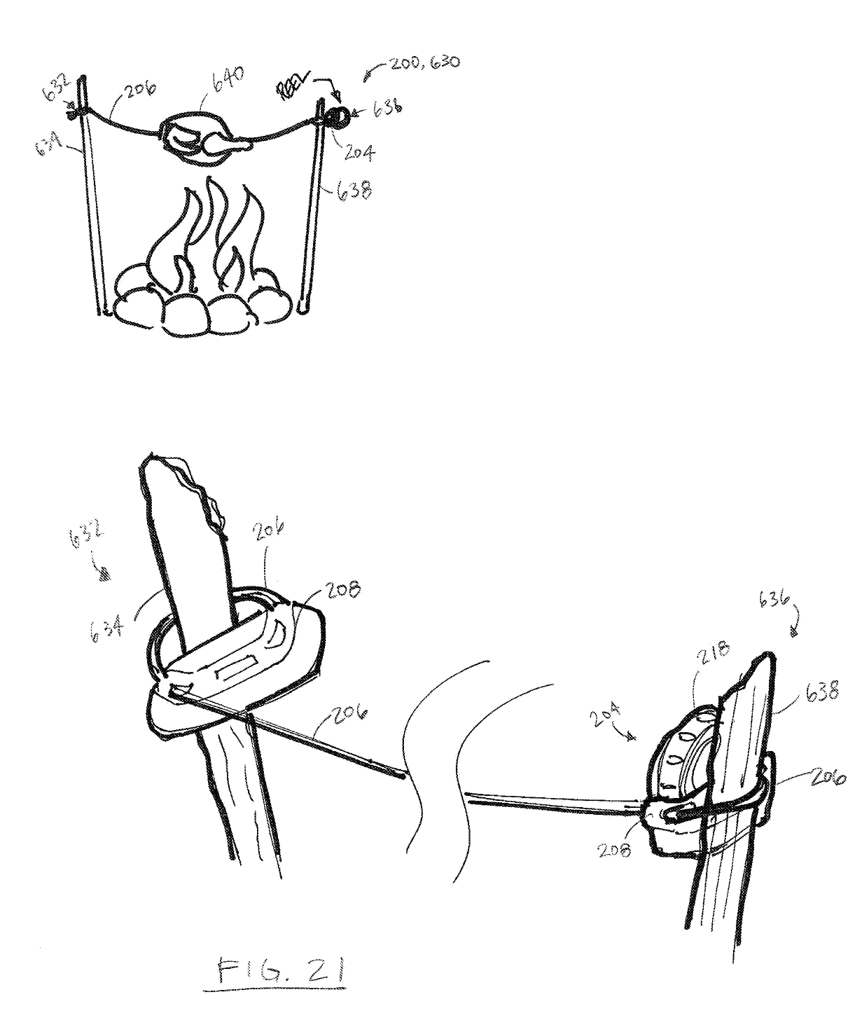

FIG. 21 shows components of the reel-based mechanism 200 functioning as a cooking spit 630. The cooking spit 630 may be utilized for hanging game meat or other foods onto the lace 206 for cooking above an open fire. More particularly, a first end 632 of the lace 206 may be attached to a guide 208 to form a slip-knot about a first pole 634, such as a tree branch. A second end 636 of the lace 206 may be threaded to another guide 208 in a slip-knot around a second pole 638. The second end 636 may further include the reel assembly 204. The lace 206 may be inserted through or otherwise secured to the game 640. In practice, rotating the knob member 218 may tighten or loosen the lace 206 to adjust the slack and thereby adjust cooking parameters of the game 640.

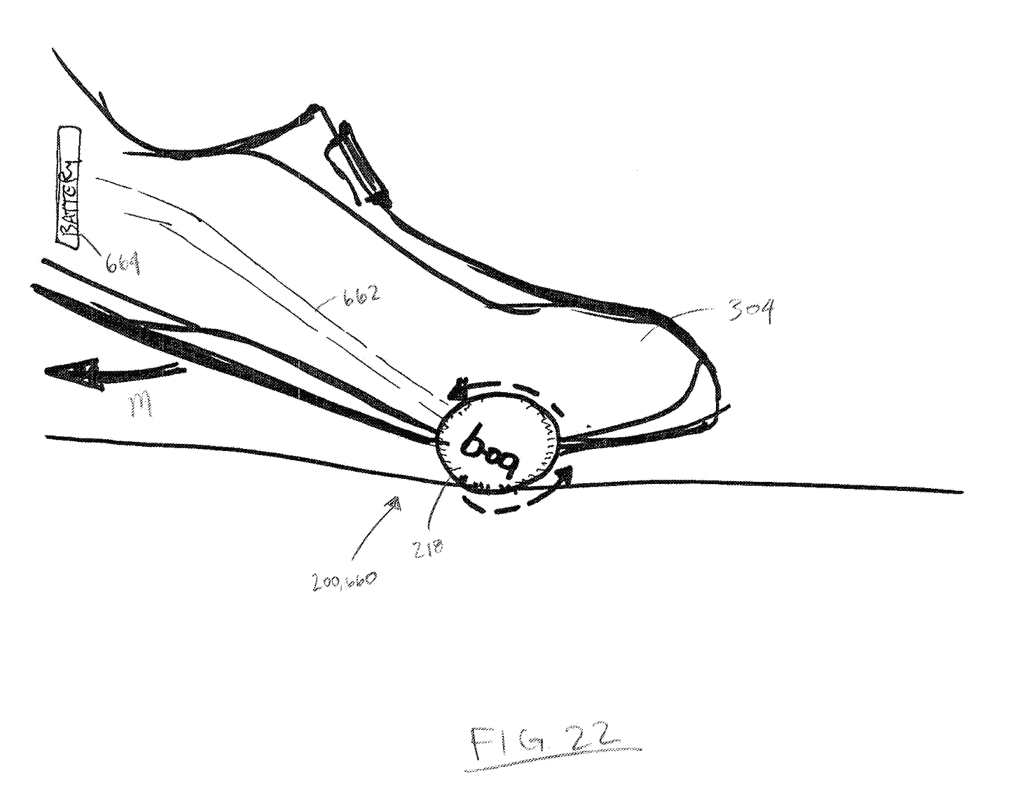

FIG. 22 shows components of the reel-based mechanism 200 functioning as a dynamo 660 or electric generator. Electricity may be generated by rotating the knob member 218 about the rotational axis 228, e.g. underneath or along a user's foot or shoe 304 moving in a direction of motion M. The knob member 218 may include a magnet (not shown) that is consequently rotated to induce an electric current in a coil of copper wiring 662, which may also be partially contained within the knob member 218 and/or the base member 214. The copper wiring 662 may be coupled with a battery 664 for charging the battery 664 and/or coupled to an electronic device for operating the device. In one example, the battery 664 may be attached to the user's shoe 304 that provides the motion M. In another example, the knob member 218 may receive a rotatable protrusion adapted to translate the motion M of the user's shoe 304 to rotation of the knob member 218.

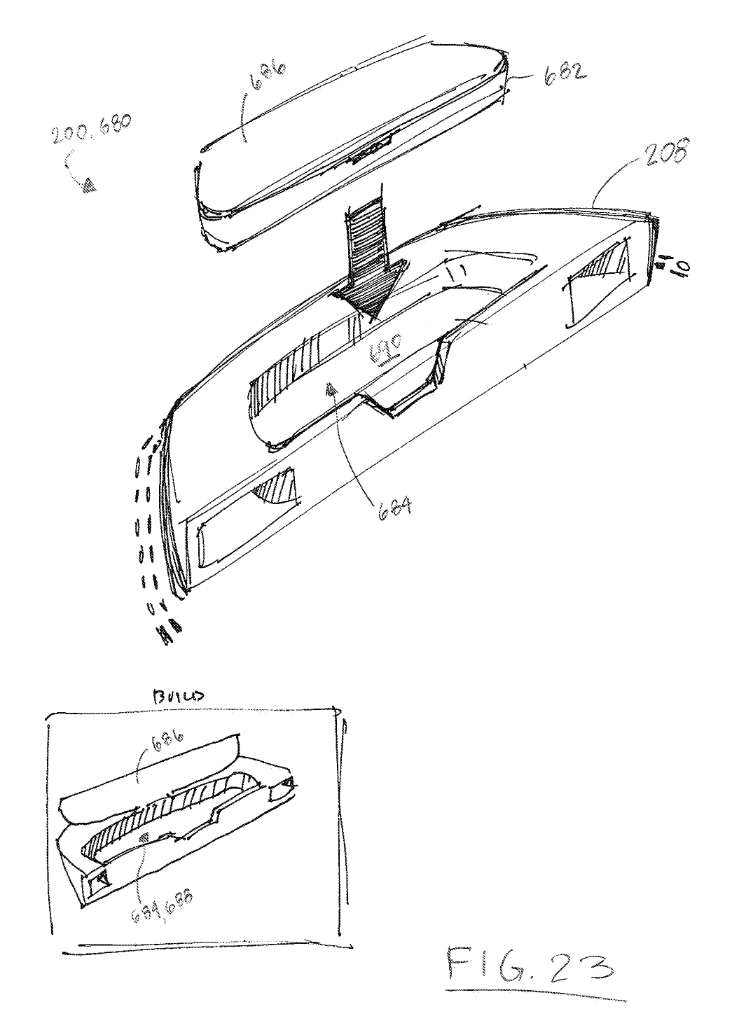

FIG. 23 shows components of the reel-based mechanism 200 functioning as a boot storage container 680. The container 680 may include a removable case 682 that may be snapped into a case mold 684 disposed on a surface of the guide 208. The removable case 682 may be elongate-shaped or otherwise to correspond to a shape of the guide 208. In another aspect, the removable case 682 includes a hinged door 686 that may be snapped shut. In another aspect, the hinged door 686 is attached to a surface of the guide 208 and provided directly over a portion of a hollow space 688, such as the case mold 684 itself, provided in the guide 208. In that case, the hinged door 686 may be integrally formed with the guide 208 and snapped shut directly on the guide 208. It is contemplated that the lace 206 wraps around the case mold 684 within the guide 208 such that the case mold 684 defines a path within the guide 208 for the lace 206 and does not interfere with threading of the lace 206 therethrough. In practice, the container 680 may be used to hold pills, fishing hooks, band-aids, and any other items that may fit therein. In some aspects, a bottom surface 690 of the case mold 684 may be magnetically attracted to a bottom surface of the removable case 682 secured thereto.

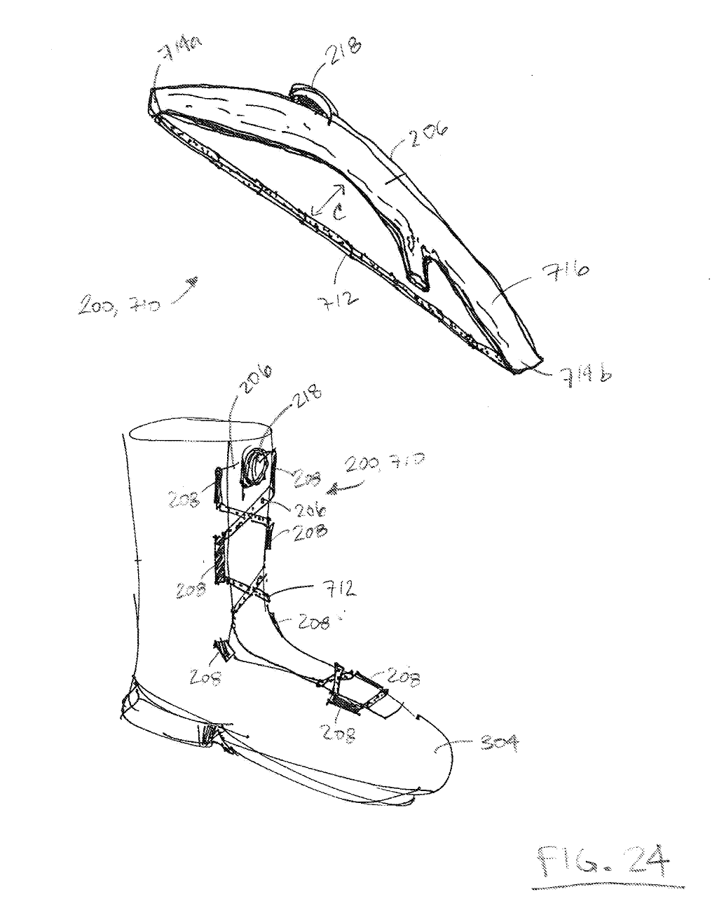

FIG. 24 shows components of the reel-based mechanism 200 functioning as a saw device 710. As shown disposed on the shoe 304, all or a portion of the lace 206 may be encased in abrasive tubing 712. The guides 208 may be configured to receive the abrasive tubing 712 therethrough and release the lace 206 having the abrasive tubing 712 by lifting off a portion of the guides 208, unhooking the abrasive tubing 712 from portions of the guides 208, or otherwise disengaging the abrasive tubing 712 from the guides 208. In practice, the reel-based mechanism 200 may be wrapped around ends 714a,b of a curved stick 716, with the abrasive tubing 712 defining a distance C from the curved stick 716. A portion of the lace 206 and/or the knob member 218 may be provided on an opposing surface of the stick 716. In practice, the knob member 218 functions as a dial for increasing or decreasing tension of the abrasive tubing 712 and/or lace 206 between the ends 714a,b. The tension may be adjusted for tightening the reel-based mechanism 200 on the stick 716. The saw device 710 may be used for cutting an object by gripping the stick 716 and providing a sawing motion so that a surface of the abrasive tubing 712 grinds against the object to be cut.

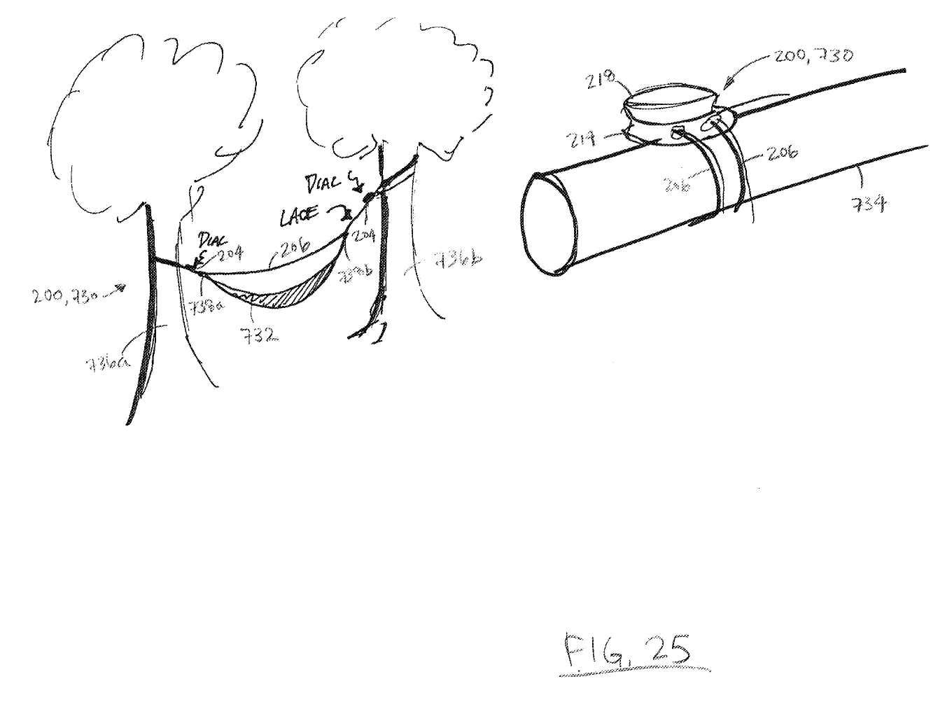

FIG. 25 shows components of the reel-based mechanism 200 functioning as a multi-purpose camp gear 730. As shown in FIG. 25, two reel-based mechanisms 200 may be operatively connected together to provide a hammock 732, or a variety of other camping tools, such as tools adapted to engage a pole 734 for a tent or clothesline structure, among other examples. For instance, two portions of lace 206 may be wrapped around two tree trunks 736a,b or other supporting rods. Each lace 206 may be tightened about the respective tree trunk 736a,b by dialing the reel assembly 204, or more specifically, by rotating the knob member 218 relative to the base member 214. Ends of the laces 206 may be tied to or otherwise engaged to opposing ends 738a,b of the hammock 732. In another example, the lace 206 may be wrapped around the pole 734 so that the base member 214 abuts snugly against the pole 734. Rotation of the knob member 218 relative to the base member 214 may tighten the lace 206 around the pole 734. Remaining portions of the lace 206 not wrapped around the pole 734 may be used as a clothesline, fishingline, or other tool.

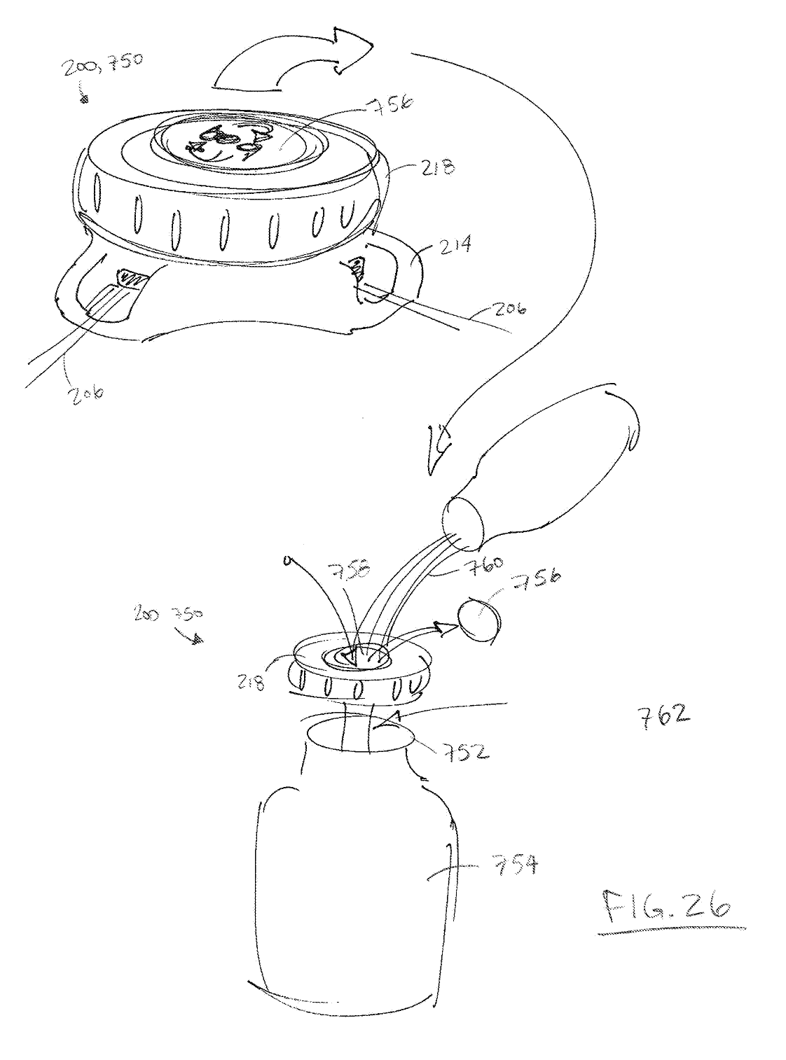

FIG. 26 shows components of the reel-based mechanism 200 functioning as a charcoal filter 750. In practice, the knob member 218 may be detached from the base member 214 and placed over an opening 752 of a bottle 754 or other object. The knob member 218 may provide a centrally-located removable cap 756 that when removed exposes a charcoal puck 758. Water 760 may be poured through the charcoal puck 758, which may filter the water flowing therethrough and provide filtered water 762 for collection in the bottle 754.

It is contemplated that the reel-based mechanism 100,200 may provide any of the above functions in any combination. Any of the features may be provided, additionally or alternatively, with any other feature described herein. The reel-based mechanism 100,200 may alternate between functioning to close and/or tighten an item, as well as to provide any of the functionalities described. Such functionalities may aid an individual in distress, aid in hastening help or rescue, aiding in surviving a dangerous situation, aid in an emergency situation, and the like. Other embodiments and implementations are possible.

What is claimed is:

1. A reel-based mechanism for tightening footwear, comprising:
a tension member;
a plurality of guide members that are positioned about an opening of the footwear and configured to guide or direct the tension member about a path along the footwear; and
a tightening mechanism that is operationally coupled with the tension member to effect tensioning of the tension member and tightening of the footwear upon operation of the tightening mechanism, wherein the tightening mechanism is configured to perform one or more secondary functions that are not related to tightening of the footwear.

2. The reel-based mechanism for tightening footwear of claim 1, wherein the tightening mechanism comprises a knob member having one or more LED lights and the one or more secondary functions comprise an LED beacon.

3. The reel-based mechanism for tightening footwear of claim 2, wherein the tightening mechanism further comprises a spool housing and a removable cover configured to be placed over the spool housing, further wherein the one or more LED beacons are disposed on at least a portion of the spool housing.

4. The reel-based mechanism for tightening footwear of claim 1, wherein the tension member and the tightening mechanism are separable from the plurality of guide members and securable to a pair of opposing handlebars disposed on opposing sides of a stretcher and the one or more secondary functions comprise a restraint gurney.

5. The reel-based mechanism for tightening footwear of claim 1, wherein the tightening mechanism comprises a knob member having a tape channel configured to secure a flexible ribbon therein and the one or more secondary functions comprise a tape measure.
